(19) United States
(12) Patent Application Publication
(10) Pub. No.: US 2017/0190030 A1
(43) Pub. Date: Jul. 6, 2017

(54) Magazine Strip and Magazine Feed for Such a Magazine Strip

(71) Applicant: adunoX GmbH, Alsfeld/Eifa (DE)

(72) Inventor: Bjoern SCHMIDT, Schotten (DE)

(73) Assignee: adunoX GmbH, Alsfeld/Eifa (DE)

(21) Appl. No.: 15/301,923

(22) PCT Filed: Mar. 31, 2015
(86) PCT No.: PCT/DE2015/000162

§ 371 Date: Oct. 4, 2016

(30) Foreign Application Priority Data
Apr. 8, 2014 (DE) 10 2014 005 105.6

(51) Int. Cl. B25B 23/04; F16B 27/00; B25C 1/00

(52) U.S. Cl. CPC B25B 23/045; B25C 1/003; F16B 27/00

(57) ABSTRACT

A magazine strip that is fed to a drive-in device via a chute extending at an angle to the drive-in direction is disclosed. A deflector consisting of tongues is provided at the outlet end of the magazine guide, which deflector deflects the magazine strip away from the straight-ahead direction and directs the magazine strip quasi upward such that the magazine strip either extends perpendicularly to the drive-in direction or even back in parallel with the insertion chute, depending on the extent of the deflection. In order that the magazine strip follows this motion, the magazine strip has hinges, the axes of which extend transversely to the longitudinal direction of the magazine strip, and thus, at an angle to the screws located in the retainers of the magazine strip.

This application claims the priority of International Application No. PCT/DE2015/000162, filed Mar. 31, 2015, and German Patent Application No. DE 10 2014 005 105.6, filed Apr. 8, 2014, the disclosures of which are expressly incorporated by reference herein.

### BACKGROUND AND SUMMARY OF THE INVENTION

The invention relates to a magazine strip with a front side and a rear side, wherein retainers for elongated fastening means are located on the front side, which retainers are aligned such that the fastening means accommodated in the retainers are parallel to each other and parallel to the front side, but run at an angle to the longitudinal extension of the magazine strip, and wherein guiding means are located on the rear side, in order to guide the magazine strip into a magazine guide.

This type of magazine strip is shown in DE 10 2011 077 433 A1. The advantage of the oblique arrangement of the magazine strip is that the fastening means, normally screws, can be packed more closely together, because the heads of the screws overlap in the top view. Because the screws are arranged at an angle to the strip, the strip must also be fed at an angle from the top to the drive-in means. The disadvantage of this is that the emptied strip runs further downward at an angle and therefore against the surface being processed, into which surface the screws are being screwed. Namely, the magazine strip kinks there, and despite everything, this prevents the screws from being positioned neatly and screwed in.

Therefore, the object of the invention is creating a magazine strip and a magazine feed suitable for accommodating such a magazine strip, which prevents the magazine strip from running against the surface being processed.

Basically, it is provided that the emptied magazine section is curved and is directed laterally out of the feed plane. In order to make this possible, the magazine strip is equipped with a plurality of hinges, the axes of which enclosing with the alignment of the retainers an acute angle that is other than zero.

The result of this is that a curvature occurs around the axis, when the magazine strip enters into the deflection means, which run parallel to the hinge axes. Because this encloses an acute angle that is other than zero, the magazine strip is not only curved laterally, but raised at the same time.

The effect is especially great if the hinge axes run perpendicular to the longitudinal extension of the magazine strip.

In the case of a progression of the hinge axes perpendicular to the longitudinal extension of the magazine strip, it is yielded with a deflection of 90° that the exiting magazine strip runs perpendicular to the drive-in direction and therefore parallel to the processed surface.

In the case of a deflection of 180°, the magazine strip runs back parallel to the inlet direction.

This effect is possibly maybe more weakly pronounced when the hinge axes do not run perpendicular to the longitudinal extension of the magazine strip.

The magazine strips are preferably produced from plastic. In order to obtain the hinge effect, it is provided that the hinges are formed from regions of the plastic strip, which are located between the projections on the rear side of the magazine strip. They reinforce the plastic strip in sections so that the areas between projections can be bent relatively easily and act like hinges.

In order to intensify and more clearly define this effect, it can be provided that the hinges are formed by thickness weakening in the magazine strip. As a matter of principle, small slits can also be provided in the hinge strip, the longitudinal extension of which defines the hinge axis.

The previously mentioned projections simultaneously serve as guiding means. To this end, each of the projections have on the upper and/or lower edges thereof, which run parallel to the longitudinal edges of the magazine strip, an undercut in which longitudinal bars of a rail in the magazine guide engage.

The retainers on the front side of the magazine strip can be designed as desired. However, it has been shown that C-shaped clips are most suitable.

A further development provides that every retainer is formed of two C-shaped clips, which are arranged one above the other as related to the retainer alignment.

The advantage of this is that the one clip, for example, can enclose the shaft of a screw and the other clip can enclose the somewhat thicker milled section of the screw, wherein both sections of the screw are retained elastically by the respective clip. With a uniform clip, it would be expanded so much by the milled section that it would no longer be able to retain the shaft of the screw.

To compensate for tolerances and thus be able to align the respective screw to the drive-in means, it is provided that every clip is connected to the magazine strip via a clip bar, which extends in the direction of the retainer.

Basically, such a double clip design can be used for every type of magazine strip and specifically also with straight magazine strips, which are not provided for an oblique feed and/or a curvature after discharging from the guide.

The invention relates furthermore to a magazine guide provided for a drive-in device. In order to achieve the deflection mentioned, it is provided that a deflector unit is located at the outlet of the chute, which deflector unit is designed such that the emptied magazine strip section exiting at the outlet of the chute is curved and is thereby directed laterally out of the chute plane, wherein the axis of curvature encloses an acute angle that is other than zero with the drive-in direction.

The deflection unit is preferably configured such that the deflection is at least 90°.

It is furthermore equipped with a feed device for the magazine strip, the special feature of which is that the feed takes place when retracting the drive-in device.

Therefore, the feed device provides for a latch, which is coupled with the drive-in device such that, when a fastening means is being driven in, the latch is retracted against the feed direction and relative to the magazine strip and moved in the feed direction when retracting the drive-in device with entrainment of the magazine strip.

The invention will be explained in greater detail in the following on the basis of an exemplary embodiment.

### BRIEF DESCRIPTION OF THE DRAWINGS

FIG. 1a is a perspective view of the front side of the magazine strip according to the invention:

FIG. 1b is a perspective view of the rear side of the magazine strip according to the invention;

FIG. 2 illustrates a first embodiment of a magazine guide according to the invention with a chute composed of two profiles for guiding the magazine strip;

FIG. 3 illustrates a second embodiment of a magazine guide according to the invention with a laser-cut chute for guiding the magazine strip;

FIG. 4 is an enlarged perspective depiction of the head of the magazine guide with a feed device for the magazine strip; and

FIG. 5 is an enlarged perspective depiction of the internal structure of the head of the magazine guide.

### DETAILED DESCRIPTION OF THE DRAWINGS

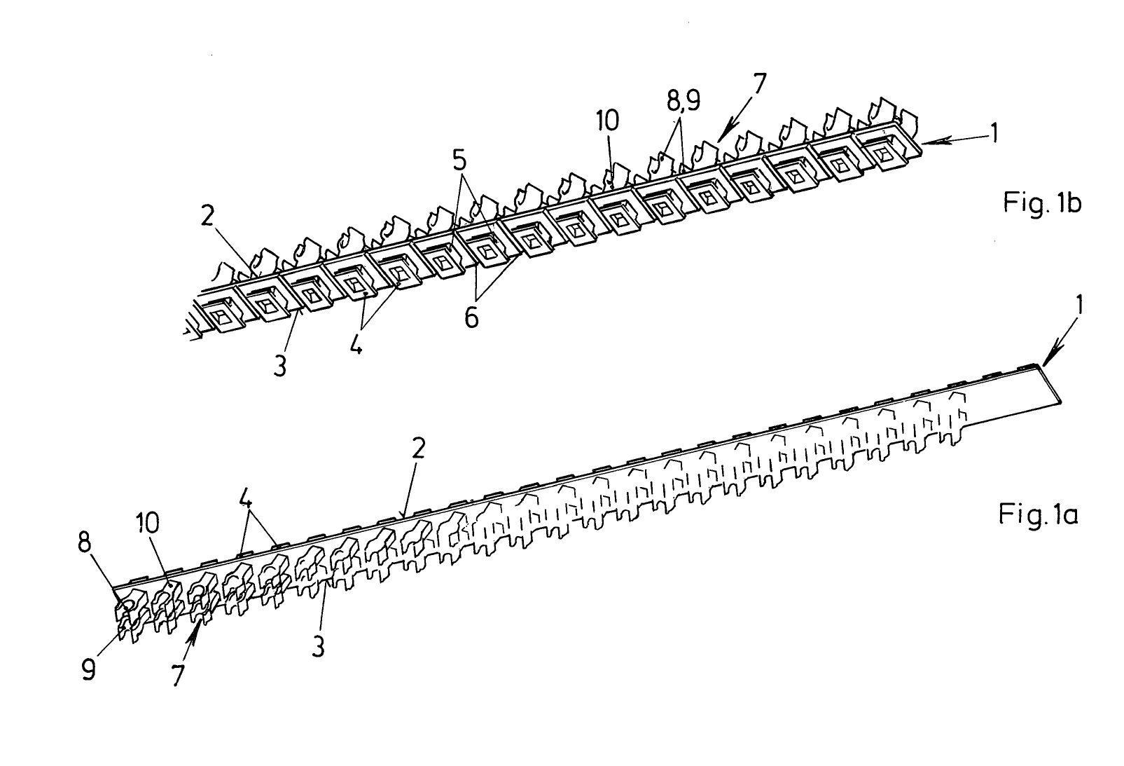

According to FIGS. 1a and 1b, the magazine strip 1 consists of a plastic strip having an upper and a lower edge 2, 3, which run parallel to each other and which determine the longitudinal extension of the magazine strip 1. Located on the rear side next to each other are a plurality of rectangular projections 4, the upper and lower edges of which facing the edges 2, 3 of the magazine strip and extending parallel to the longitudinal direction of the magazine strip each have an undercut 5.

Linear, thinned regions in the strip, which constitute the hinges 6, run between the projections 4 perpendicular to the upper and lower edges 2, 3.

Located on the front side are retainers 7 for screws, which consist of two C-shaped clips 8, 9 that are arranged one above the other, and each of which is attached to the magazine strip via a clip bar 10. The clips are indicated only schematically on part of the strip. Every retainer 7 is located in a region, which is limited laterally on the rear side by two weakening lines, which form the hinges 6.

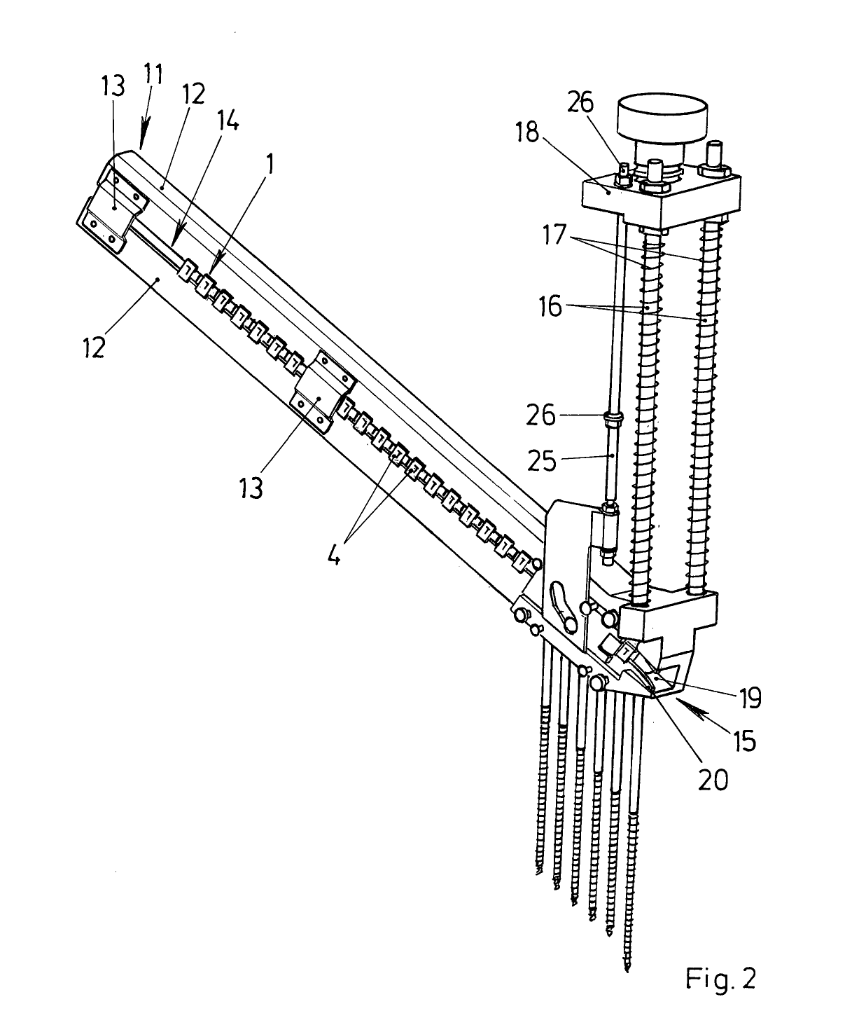

To guide such a magazine strip 1, a magazine guide, as shown in FIG. 2, is provided, which consists of a chute 11, which is C-shaped or L-shaped in section and formed by two profiles 12, which are connected to each other via brackets 13 so that a continuous slit 14 is formed, the edges of which form bars which engage in the undercuts 5 of the magazine strip 1.

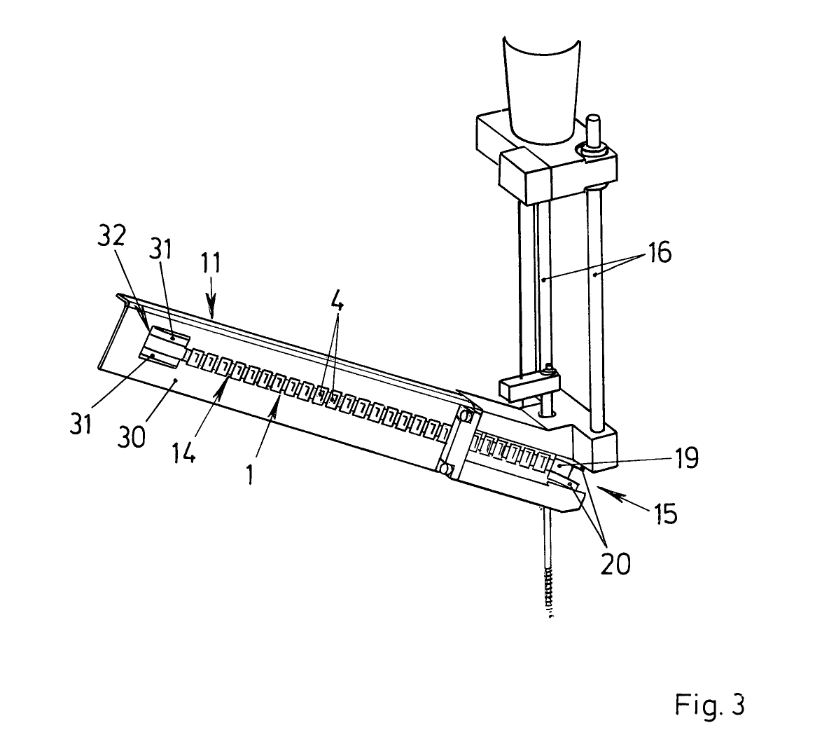

FIG. 3 shows an alternative design of the magazine guide. Instead of two angle profiles, which are connected to each other via bridges, an L-shaped rail 30 is provided, into the base of which the slit 14 has been cut, e.g., by means of a laser. Two threading flaps 31 have been provided at the beginning of the slit to thread in a webbing, the inner edges of which threading flaps constitute an extension of the inner edges of the slit 14 and which are bent out of an opening 32 in the base of the rail, the width which is greater than the width of the slit 14.

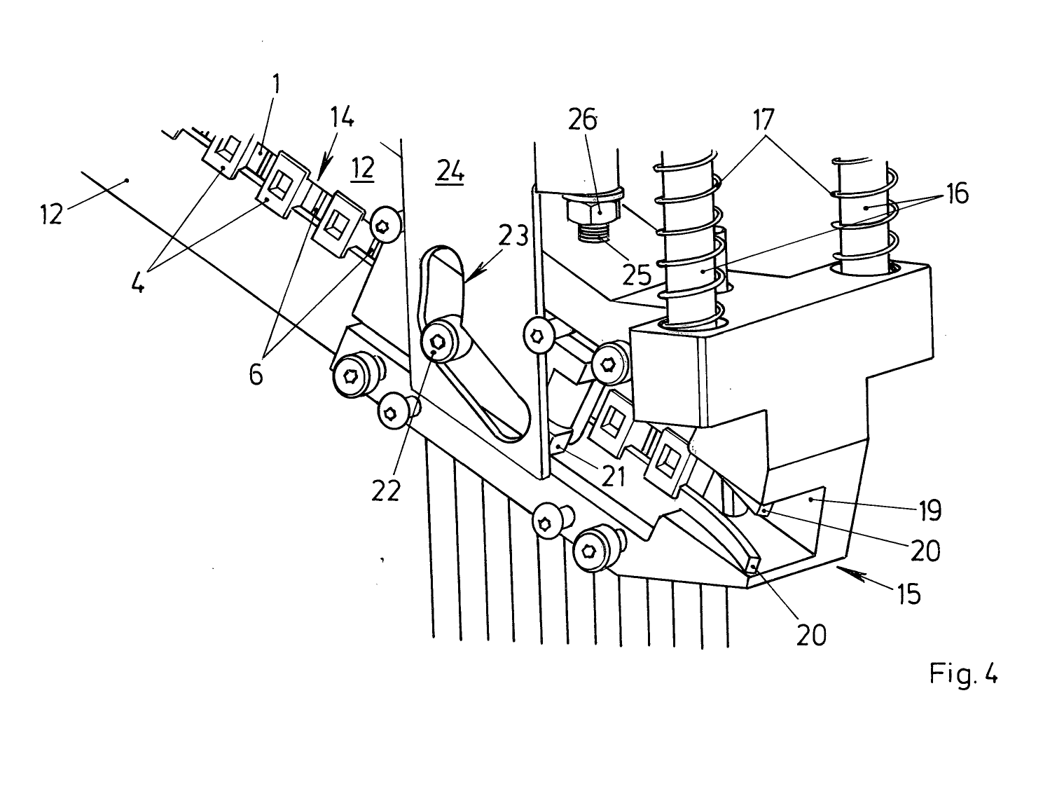

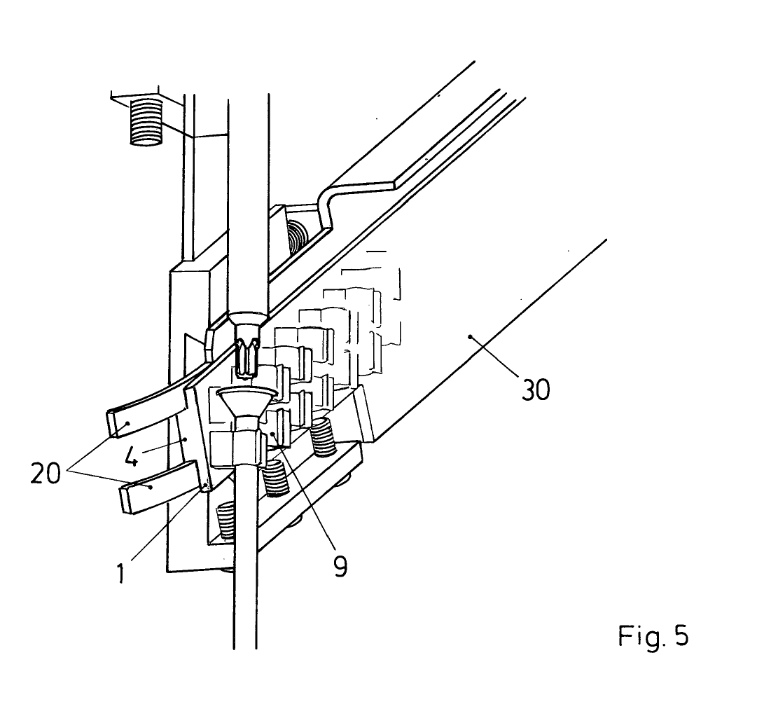

As depicted in FIGS. 4 and 5, in both designs the chute 11 guides into a head 15 with a passage for a screw tool. Two guide rods 16, on each of which a helical spring 17 is situated, project upwardly from the upper side of the head 15. An adapter 18 is guided by the guide rods 16, and the adapter is used to accommodate a drive-in device (not shown here in greater detail), e.g., a screwdriver. To drive in a screw, the screwdriver is guided against the head 15, wherein the helical springs 17 are compressed so that so that they reset the screwdriver again upon completion of the drive-in process.

The head 15 comprises a cross groove 19, which extends the chute 11 into the head 15, wherein a tongue 20 extending the slit 14 leads from each of the profiles 12, which form the chute 11, into the cross groove 19. The tongues 20 are bent sideways out of the cross groove 19 so that the emptied magazine strip section from which the screws have been unscrewed is directed to the side. Because the hinges 6 of the magazine strip 1 run perpendicular to the edges 2, 3 of the magazine strip 1, the magazine strip 1 is raised at the same time by the curvature thereof. In the case of a deflection of 90°, the magazine strip 1 runs beyond the head 15 perpendicular to the drive-in direction. In the case of a deflection of 180°, the magazine strip 1 returns parallel to the chute 11 again and does not constitute an impediment as a result.

In the enlarged depiction, particularly FIG. 5, the two tongues 20 can be seen again in the extension of the chute 11.

The feed device is depicted in more detail in FIG. 4. The device consists of a latch 21, which engages flexibly pre-tensioned in the interstice between two projections 4. The latch 21 has a sliding block 22, which is arranged in the slotted piece 23 of a slider 24.

As FIG. 2 shows, the slider 24 is connected to a rod 25 (a depiction of the slider 24 was dispensed with in FIG. 2), which rod passes through the adapter 18 and is provided with limit stops 26 formed by nuts on both sides of the adapter 18, which have a distance to each other that defines an idle movement. The slotted piece 23 is set up so that, when the slider 24 is pressed down, the latch 21 is pulled rearward, i.e., against the feed device, and therefore pulled over the projection 4 lying behind it and is applied again on the rear side of the projection 4 (see FIG. 3).

When the drive-in device is driven back when the manual actuation force abates through the force of helical springs 17, the adapter takes the slider 24 with it after an idle movement, whereby the latch 21 is slid in the feed direction and in doing so takes the magazine strip 1 with it. The force required for the feed is therefore made available by the helical springs 17. The advantage of this over a feed device in which the feed takes place with the initial compression of the helical springs 17 is that the actuation path of the adapter 18 can be shorter, because it is possible to start screwing in immediately and a screw does not have to be placed under the screwdriver first.

This design of the feed device can basically also be used if the aspects of the invention related to the deflection of the magazine strip 1 are not used.

List of Reference Numbers:

| | |
|---|---|
| 1 | Magazine strip |
| 2 | Upper edge |
| 3 | Lower edge |
| 4 | Projections |
| 5 | Undercut |
| 6 | Hinge |
| 7 | Retainer |
| 8 | Clip |
| 9 | Clip |
| 10 | Clip bar |
| 11 | Chute |
| 12 | Profiles |
| 13 | Brackets |
| 14 | Slit |
| 15 | Head |
| 16 | Guide rods |
| 17 | Helical springs |
| 18 | Adapter |
| 19 | Cross groove |
| 20 | Tongues |
| 21 | Latch |
| 22 | Sliding block |
| 23 | Slotted piece |
| 24 | Slider |
| 25 | Rod |
| 26 | Limit stops |
| 30 | Rail |
| 31 | Threading flaps |
| 32 | Opening |

1.-10. (canceled)

11. A magazine strip, comprising:
a front side and a rear side, wherein a plurality of retainers are disposed on the front side and wherein the plurality of retainers are aligned such that a plurality of fasteners respectively accommodatable in the plurality of retainers are parallel to each other, parallel to the front side, and run at an angle to a longitudinal extension of the magazine strip;
a guide disposed on the rear side, wherein the magazine strip is guidable by the guide into a magazine guide; and
a plurality of hinges, wherein a respective axis of the plurality of hinges encloses an acute angle that is other than zero with an alignment of the plurality of retainers.

12. The magazine strip according to claim 11, wherein the respective axis of the plurality of hinges runs perpendicular to the longitudinal extension of the magazine strip.

13. The magazine strip according to claim 11, wherein the magazine strip is a plastic and wherein the plurality of hinges are formed from respective regions of the plastic which are located between projections on the rear side of the magazine strip which form the guide.

14. The magazine strip according to claim 11, wherein the magazine strip is plastic and wherein the plurality of hinges are formed by a thickness weakening in the magazine strip.

15. The magazine strip according to claim 11, wherein the guide includes a plurality of projections, wherein each of the plurality of projections has an undercut on a respective upper edge and/or on a respective lower edge, which respective upper and lower edges run parallel to longitudinal edges of the magazine strip.

16. The magazine strip according to claim 11, wherein each of the plurality of retainers has two C-shaped clips which are disposed one above the other.

17. The magazine strip according to claim 16, wherein the two C-shaped clips are connected via a clip bar to the magazine strip and wherein the clip bar extends in the alignment of the plurality of retainers.

18. A magazine guide for a drive-in device, comprising:
a straight chute;
a magazine strip, wherein a plane of the magazine strip lies in a plane of the straight chute;
an adapter for fastening a drive-in device, wherein the adapter is aligned such that the plane of the straight chute is parallel to a drive-in direction of the drive-in device and wherein a longitudinal extension of the straight chute runs at an angle to the drive-in direction of the drive-in device; and
a deflector unit disposed at an outlet of the chute, wherein an emptied magazine strip section of the magazine strip exiting at the outlet of the chute is directed by the deflector unit out of the plane of the straight chute.

19. The magazine guide according to claim 18, wherein the emptied magazine strip section of the magazine strip exiting at the outlet of the chute is directed by the deflector unit out of the plane of the straight chute by at least 90°.

20. The magazine guide according to claim 18 in combination with a feed device for the magazine strip and a drive-in device, comprising:
a latch, wherein the latch is coupled with the drive-in device such that, when a fastener is being driven-in the latch is retracted against a feed direction and relative to the magazine strip and when the drive-in device is retracted the latch is moved in the feed direction with entrainment of the magazine strip.
